(19) United States
(12) Patent Application Publication
(10) Pub. No.: US 2008/0315084 A1
(43) Pub. Date: Dec. 25, 2008

(54) ANALYSIS METHOD OF AMINO ACID USING MASS SPECTROMETER

(75) Inventors: Naoyuki YAMADA, Kawasaki-shi (JP); Satoko Akashi, Yokohama-shi (JP); Koichi Suzuki, Kyoto-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: AJINOMOTO CO. INC, Tokyo (JP); SHIMADZU CORPORATION, Kyoto-shi (JP)

(21) Appl. No.: 12/140,099

(22) Filed: Jun. 16, 2008

Related U.S. Application Data
(63) Continuation of application No. PCT/JP2006/324735, filed on Dec. 12, 2006.

(30) Foreign Application Priority Data
Dec. 16, 2005 (JP) 2005-363512

(51) Int. Cl. B01D 59/44

(52) U.S. Cl. 250/288

(57) ABSTRACT

A pretreatment method of samples, in which injections of samples are performed efficiently and precisely when amino acids are analyzed with a mass spectrometer, is provided. For the analysis method of samples including analyte comprising an amino acid, an amine and/or a peptide with mass spectrometry, the analyte is derivatized with a modification reagent, the derivative is subjected to a microchip electrophoresis, and then eluate from the microchip electrophoresis is introduced into a mass spectrometer.

### CROSS REFERENCES TO RELATED APPLICATIONS

This application is a continuation of International Patent Application No. PCT/JP2006/324735, filed on Dec. 12, 2006, and claims priority to Japanese Patent Application No. 2005-363512/2002, filed on Dec. 16, 2005, both of which are hereby incorporated herein by reference in their entireties.

### BACKGROUND OF THE INVENTION

1. Field of the Invention

The present invention relates to methods of analyzing amino acids and the like using a mass spectrometer. The method further relates to methods of pretreating a sample to be analyzed and such pretreated samples for such a method of analysis and a method of efficiently supply samples to a mass spectrometer for analysis.

2. Discussion of the Background

For analyzing amino acids, a method using an amino acid analyzer is the most precise and it has been popularized widely. However, there are problems of a very long analysis time of 1 to 2 hours and relatively low sensitivity of 10 to 50 μmol. In order to overcome the problem of the sensitivity, a method for performing ultraviolet labeling or fluorescence labeling has been developed and its sensitivity has been improved to around 100 fmol by fluorescence detection, but a further improvement of the sensitivity has been desired. In addition, the problem of the analysis time has not been solved yet.

Recently, a shortening of the analysis time has been achieved together with an improvement of the sensitivity by combining the fluorescent labeling with a liquid chromatography mass spectrometer (herein below, it is called as LC-MS) (see, WO03/069328A1). By using this method, the analysis time can be cut as much as 20 minutes. The sensitivity depends on the performance of the mass spectrometers, but it can be quantified at most several fmol if using an expensive tandem mass spectrometer.

However, the demand for analyzing amino acids is widespread widely, and a further sensitivity and a high speed of the analysis are desired. As far as liquid chromatography is used, improvement of the performance has reached its limit and a development of new method not using the liquid chromatography is desired.

On the other hand, capillary electrophoresis is used as a separation method of very small amounts of charged substances like ions, organic acids, amino acids, peptides, proteins, nucleic acids, saccharides, and so on. Capillary electrophoresis is a general method to separate a charged molecule in a solution. A method for analyzing amino acid by CE/MS/MS combining capillary electrophoresis (CE) with tandem mass spectrometry (MS/MS) is known (see, Soga et al., Electrophoresis, vol. 25, pp. 1964-1972 (2004)). The analysis time is 15 minutes and the sensitivity is several fmol even though using this method, so a great improvement has not been achieved yet. On the other hand, a micro total analysis system (μ-TAS) which accumulated miniaturized conventional analysis instruments and reaction instruments on a chip substrate has been researched and developed vigorously in recent years and it has reached to a practical use level. A method of performing the capillary electrophoresis (microchip electrophoresis: μchip CE) by using a microchip provided with fine processing on a base material such as glass substrate and polymers is a main technique of the μ-TAS (see, Gerard J. M. Bruin, Electrophoresis, vol. 21, pp. 3931-3951 (2000), and Lee, S. J. and Lee, S. Y., Appl. Microbiol. Biotechnol., vol. 64, pp. 289-299 (2004)). Also, μchip CE/MS, in which a mass spectrometer as a detector is connected to the μchip CE, is a superior instrument which is very sensitive and able to obtain information of mass. By using the μchip CE/MS or the capillary electrophoresis-MS, amino acids and peptides and the like can be separated and analyzed around 90 seconds to 15 minutes (see, Japanese Patent Kokai Publication No. JP-P2001-83119A and Y. Tachibana, K. Otsuka, S. Terabe, A. Arai, K. Suzuki, S, Nakamura, J. Chromatography A, vol. 1025, pp. 287-296 (2004).

Sample migration and injection in the μchip are performed using potential difference. A method is used in which plural reservoirs including sample, buffer, and reagent are connected in fine channels and charged molecule like sample are migrated due to voltage difference between reservoirs. In order to perform the separation and quantification analysis precisely using the μchip CE, it is important to control the injection volume of sample accurately. In order to inject sample more accurately, a microchip having a structure for regulating sample volume has been developed (see, Japanese Patent Kohyo Publication No. JP-A-10-507516, Japanese Patent Kokai Publication No. JP-P2005-164242A, and Japanese Patent Kokai Publication No. JP-P2001-242137A).

On the other hand, a spray ionization mass spectrometer is a high-throughput analysis instrument which can measure mass in high sensitivity and within several minutes. A bottleneck for short time analysis in the mass spectrometer is injection time of sample. Especially, the required time for introducing samples takes at least 1 minute or more when continuous analysis is performed with an existent auto injector, thereby it cannot make sufficient use of performance of the mass spectrometer. As a method for supplying samples to the mass spectrometer faster, there is a system using an acoustic injector (see, Japanese Patent Kokai Publication No. JP-P2004-205510A). In this method, using a microwell plate containing solution sample of multiple specimen, droplets are generated by acoustic pulses successively from samples in the microwell plate to be supplied to the mass spectrometer. However, this method has not been realized yet. Moreover, it is impossible in principle to combine this method with the t-TAS which is expected to be developed in the future.

Thus, there remains a need for a more efficient method for analyzing amino acids and other charged compounds.

### SUMMARY OF THE INVENTION

In an analysis method using a microchip, it has been made an effort to adjust injection volume of samples precisely. On the other hand, the capillary electrophoresis is a technique to separate depending on differences of electric properties of object materials to be measured. Therefore, in the case of introducing samples into separation channels in a microchip electrophoresis, each mobility of samples is different depending on differences of electric properties of object materials to be measured. In the case of mixture samples comprising plural compounds, because each mobility of mixture samples to introduce into the separation channels is different even if injection volume of samples can be uniform, there is liability to change the existence ratio of compounds in the whole sample solution. This phenomenon is serious problem for performing a quantitative analysis with the μchip CE, and this phenomenon causes a decrease of the signal intensity of the detection peak. Especially, in the case of compounds in which electric properties are greatly different like amino acids, saccharide, peptides and organic acids, it is more serious problem because the signal intensity of the detection peak greatly depends on pH and salt concentration of buffer to be used.

In conventional techniques having such kinds of problems, the present invention resides in providing a pretreatment method of samples, in which injections of samples are performed efficiently and precisely when amino acids are analyzed with a mass spectrometer.

Accordingly, it is one object of the present invention to provide novel methods for analyzing amino acids, amines, and peptides.

It is another object of the present invention to provide novel methods for analyzing amino acids, amines, and peptides which overcome some or all of the above-mentioned drawbacks of conventional methods.

These and other objects, which will become apparent during the following detailed description, have been achieved by the inventors' discovery that derivatization of amino acids with a modification reagent, subjecting the amino acid derivatives to microchip electrophoresis, and then introducing the amino acid derivatives into a mass spectrometer is an efficient method of analyzing amino acids. Thereby, they have found that not only the injections of the samples are performed efficiently but also the precision of the injection volume is improved.

Thus, the present invention provides the following:

(1) An method of analyzing a sample which contains an analyte comprising one or more members selected from the group consisting of an amino acid, an amine, and a peptide, by a mass spectrometry, said method comprising:

(a) derivatizing said analyte is derivatized with a modification reagent, to obtain a derivative;

(b) subjecting the derivative to a microchip electrophoresis, to obtain an eluate; and

(c) introducing the eluate into a mass spectrometer.

(2) The method according to the above (1), wherein the derivatizing comprises converting an amino group or an imino group of the analyte into any one of a carbamoyl group, a thiocarbamoyl group, a tertiary amine, or a quaternary ammonium salt.

(3) The method according to the above (1), wherein the derivative has a structure of a tertiary amine or a quaternary ammonium salt having an aromatic ring, and the structure is easy to ionize in the mass spectrometry.

(4) The method according to any one of the above (1) to (3), in which the derivative has a structure shown in any one of following general formulae (1) to (9):

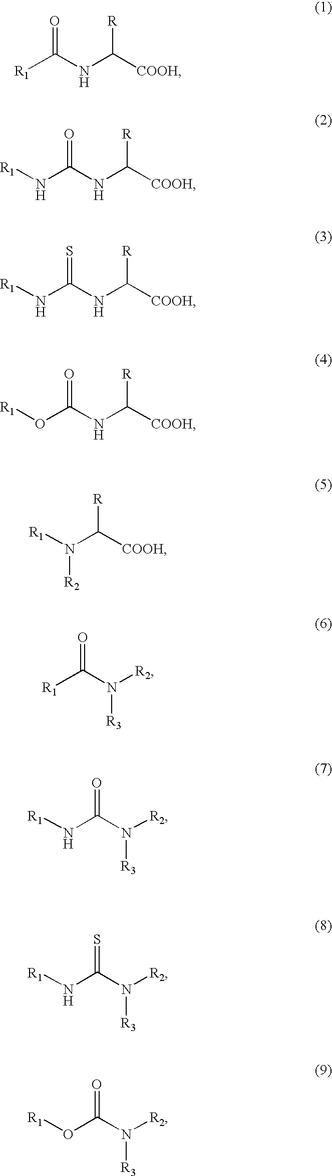

wherein in the above formulae (1) to (9), R represents a hydrogen atom or an alkyl group which may have a substituent group and is a side chain of an amino acid, R₁ represents an alkyl group which may have a substituent group or a substituted or unsubstituted group having an aromatic carbocyclic ring or an aromatic heterocyclic ring, R₂ and R₃ each independently represent an alkyl group which may have a substituent group, or R₂ and R₃ together may form a ring, or when one of R₂ and R₃ represents an amino acid residue of peptide, the other can be hydrogen atom.

(5) The method according to any one of the above (1) to (4), wherein the modification reagent is at least one compound selected from the group consisting of acetic aid anhydride, N-acetyl-imidazole, N-acetyl-succinimide, N-acetyl-imidoacetate, N-acetyl-imidazole, Bolton-Hunter reagent, a carbamate compound, an isothiocyanate compound, an N-hydroxy-succinimide-ester, dansyl-chloride, dabsyl-chloride, dansyl-fluoride, and NBD-F(4-fluoro-7-nitrobenzofurazan).

(6) The method according to the above (5), wherein the carbamate compound is selected from the group consisting of 6-aminoquinolyl-N-hydroxysuccinimidyl-carbamate (AQC), p-dimethylaminoanilyl-N-hydroxysuccinimidyl-carbamate (DAHS), 3-aminopyridyl-N-hydroxysuccinimidyl-carbamate (APDS), p-trimethylammoniumanilyl-N-hydroxysuccinimidyl-carbamate-iodide (TAHS), aminopyrazyl-N-hydroxysuccinimidyl-carbamate, 9-aminoacridyl-N-hydroxysuccinimidyl-carbamate, and 1-naphthylamino-N-hydroxysuccinimidyl-carbamate.

(7) The method according to the above (5), wherein the isothiocyanate compound is phenyl isothiocyanate or fluorescein isothiocyanate.

(8) The method according to any one of the above (1) to (7), wherein the mass spectrometer is one selected from the group consisting of an electro-spray-ionization mass spectrometer, an atmospheric pressure chemical ionization mass spectrometer, a cold-spray-ionization mass spectrometer, and a laser-spray-ionization mass spectrometer.

(9) A method for supplying samples including plural analytes comprising amino acid(s), amine(s) and/or peptide(s) to an analysis instrument, in which the analytes are reacted with a modification reagent to prepare any one of derivatives shown in the above general formulae (1) to (9), then an electrophoresis of the derivative is performed with a microchip electrophoresis device, and then eluate from the microchip electrophoresis is supplied to an inlet(s) of the analysis instrument.

(10) A pretreatment instrument for analyzing samples including plural analytes comprising amino acid(s), amine(s) and/or peptide(s) with a mass spectrometer, in which the pretreatment instrument has a reaction part for preparing the derivative described in the above (9) by reacting the analytes with a modification reagent and a microchip electrophoresis part for performing an electrophoresis of the derivative.

The meritorious effects of the present invention are summarized as follows. According to the present invention, each sample introduction for analyzing amino acid by the mass spectrometer is performed efficiently, thereby many samples can be analyzed in a short time compared to the conventional method. Also, the precision of the injection is improved and the quantifiability is improved, too.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1A is a mass elecropherogram of analyzing 17 amino acids in Example 1;

FIG. 1B is a mass elecropherogram of analyzing 17 amino acids in Example 1;

FIG. 2 is a mass elecropherogram (left) and mass specta (right) of analyzing 17 amino acids in Example 2; and

FIG. 3 is a mass elecropherogram of analyzing a mixture of 4 amino acids in Example 3.

### DETAILED DESCRIPTION OF THE PREFERRED EMBODIMENTS

When samples are migrated by potential difference in the μ-TAS, each mobility of samples is different depending on differences of electric properties of object materials to measure. In the case of mixture samples comprising plural compounds, even if injection volume of samples can be made uniform, there is the possibility of causing a change in the existence ratio of compounds in the sample solution, because each mobility of compounds mixture samples to reach the injection part is different. This phenomenon is serious problem especially for performing a quantitative analysis with the μ-TAS, and this phenomenon causes a decrease in the signal intensity of the detection peak and a deterioration of quantitative sensitivity. Especially, in the case of compounds whose electric properties are greatly different like amino acids, saccharides, peptides, and organic acids, it is a more serious problem, because the signal intensity of the detection peak greatly depends on pH and salt concentration of buffer to be used. The pKa values of biologic molecules like amino acids, peptides, organic acids, and nucleic acids vary around the neutral neighborhood. This variety of a pKa value is expressed as a difference of mobility. This is remarkable, especially for amino acids having an amino group and an carboxyl group. The pKa of an amino group is greatly different depending on the kind of amino acid. Therefore, in the method of the present invention, the amino group is modified with a modification reagent to not have basicity or introduction of molecules having a larger pKa or a smaller pKa, so it is possible to reduce the difference of pKa for the method of the present invention. Thereby, the difference of mobility when introducing samples can be reduced.

For the present invention, samples which become the object of the analysis include analytes which comprise amino acids, amines (primary amine, secondary amine and the like) and/or peptides. These analytes are compounds (they may be in the form of salt) having amino group(s) and/or imino group(s) in molecule, and the amino group and imino group may be one or plural. Also, analytes existing in samples may be one kind or mixture of plural kinds, but the present invention takes effect in the case of analytes including plural compounds. In concrete, analytes include 20 kinds of natural amino acids, in addition hydroxylysine and hydroxyproline or non-natural amino acids such as homocysteine and homoserine and the like, and amines such as histamine and ornithine and the like. Analytes may include a plurality of kinds of such compounds. Peptides, in which several amino acids are connected to form dipeptide or tripeptide, are also encompassed in the analytes of the present invention. In recent years, proteomics aimed for comprehensive analysis of protein has been played an important role in the life science research field. In general proteomics, object protein to be analyzed is digested by trypsin to make peptide fragments and measured with the mass spectrometer. Because trypsin is an enzyme to digest protein at carboxyl terminus of lysine residue or arginine residue, peptides to be generated are peptides having one residue of lysine or arginine at C terminal. Since peptides prepared in such way have limited reaction sites with the modification reagent concerning the present invention, they can be analyzed easily by the method of the present invention as well as amino acid or amine.

Many means are known for a derivatization method of amino group of amino acids (see, e.g., The Japanese Biochemical Society, New Biochemical Experiment Course 1, Protein IV structural activity correlation, Chapter 2). As a derivatization method in which positive charge of amino group is maintained, there are derivatizations of guanidine or amidine. For regulation of pKa which is main point of the present invention, it is preferred to convert amino group into a carbamoyl group by carbamoyl derivatization or acetylation, or into a thiocarbamoyl group by thiocarbamoyl derivatization. As the acetylation reagent, there are acetic aid anhydride, N-acetyl-imidazole, N-acetyl-succinimide, N-acetyl-imidoacetate, N-acetyl-imidazole, Bolton-Hunter reagent, and the like. Also, a carbamate compound, as is well known for labeling amino group of amino acids or peptides, an isothiocyanate compound, a N-hydroxy-succinimide-ester, and alkylating agent(s) like dansyl-chloride, dabsyl-chloride, dansyl-fluoride, and the like can be used. In the concrete, a carbamate compound to generate derivatives described in the above formula (1) by reacting with amino acids is preferred. In more detail example, 6-aminoquinolyl-N-hydroxysuccinimidyl-carbamate (AQC), p-dimethylaminoanilyl-N-hydroxysuccinimidyl-carbamate (DAHS), 3-aminopyridyl-N-hydroxysuccinimidyl-carbamate (APDS), p-trimethylammoniumanilyl-N-hydroxysuccinimidyl-carbamate-iodide (TAHS), aminopyrazyl-N-hydroxysuccinimidyl-carbamate, 9-aminoacridyl-N-hydroxysuccinimidyl-carbamate, 1-naphthylamino-N-hydroxysuccinimidyl-carbamate, and the like are preferred. Also, isothiocyanate compound(s) to generate derivatives described in the above formula (2) by reacting with amino acid(s) is listed, in more detail, phenyl isothiocyanate, fluorescein isothiocyanate, and the like are listed. In addition, an amino group can be converted into a carbamoyl group by introducing general protective group of amino groups such as benzyloxycarbonyl (Z) group, t-butoxycarbonyl (Boc) group or 9-fluorenylmethoxycarbonyl (Fmoc) group (see, e.g., The Japanese Biochemical Society, Forth version Experimental Chemistry Course 22, Organic Synthesis IV, Acid/Amino Acid/Peptide, Chapter 2 third section, Synthesis of protective amino acid, Maruzen).

Also, in order to improve the sensitivity of the mass spectrometry, a derivatization having charge is more preferred. Considering the above charge regulation effect, derivatives having a tertiary amine or a quaternary ammonium salt having aromatic ring are more preferred. In more detail example, 6-aminoquinolyl-N-hydroxysuccinimidyl-carbamate (AQC), p-dimethylaminoanilyl-N-hydroxysuccinimidyl-carbamate (DAHS), 3-aminopyridyl-N-hydroxysuccinimidyl-carbamate (APDS), p-trimethylammoniumanilyl-N-hydroxysuccinimidyl-carbamate-iodide (TAHS), aminopyrazyl-N-hydroxysuccinimidyl-carbamate, 9-aminoacridyl-N-hydroxysuccinimidyl-carbamate or 1-naphthylamino-N-hydroxysuccinimidyl-carbamate and the like can be used, and an effect for improving the sensitivity in the mass spectrometry is also achieved.

Derivatized amines or amino acids can be detected and quantified by performing the microchip electrophoresis and analyzing the mass spectrometer. Since a mass separation can be performed with the mass spectrometer without performing separation of compounds in a microchip, channels length of a microchip usually used for separation can be shortened as much as possible, then great cut of an analysis time can be realized. Thereby, an auto-injector which can inject accurate volume is made without changing the ratio of sample composition or concentration of sample. As a result, according to the present invention, the stabilization of the quantity of introduction samples, the high sensitivity, and the high speed of the analysis time can be achieved at the same time.

On the other hand, in the microchip electrophoresis, there is a method to use reverse-phased carrier, besides the capillary electrophoresis. By performing together with this method, compounds having same mass can be separated, for example in amino acids, leucine and isoleucine can be separated.

In general, for the 1-TAS, a potential difference is frequently used when samples or reagent are migrated. Therefore, according to the present invention, it can be possible to have uniform mobility for compounds having different mobilities, and it can be widely applied to the μ-TAS.

As the mass spectrometry used in the present invention, a method is used wherein liquid containing samples eluted from the above microchip electrophoresis are sprayed into mist, followed by introduction into a spraying instrument for ionization, and then the sample is measured in a gas phase. As the spraying instrument, there are an electro-spray-ionization method (ESI), an atmospheric pressure chemical ionization method (APCI), a cold-spray-ionization mass spectrometer (CSI), a laser-spray-ionization method (LSI) and the like, but it is not limited to the above listed. Generated ions are applied to the mass spectrometry, and they are separated into with mass-to-charge ratio (m/z) by applying various different voltages to electrode. This mass analysis part plays an important role for sensitivity and resolution of analyzed data, accuracy of mass, or abundant information obtained from mass spectrum data. The separation methods of ions, may be currently classified into six basic types, that is, magnetic field type, electric field type, ion-trap type, time-of-flight (TOF) type, quadrupole type, and Fourier transform cyclotron type. They each have positive aspect and negative aspect, respectively, and they can be used alone or in combination each other, whereas a quadrupole mass spectrometer is usually used for ionization due to the ESI. In addition, it provides certainty in the measurement and interpretation of multiply-charged ions by connecting plural quadrupoles in tandem (MS/MS).

Other features of the invention will become apparent in the course of the following descriptions of exemplary embodiments which are given for illustration of the invention and are not intended to be limiting thereof.

### EXAMPLES

### Example 1

### Derivatization of Amino Acids

20 μl of 17 kinds of amino acids mixture standard solution, Type H (Wako Jyunyaku) was added to 60 μl of boric acid buffer (0.2M borate, pH8.8) and mixed well. Then, 20 μl of 6-aminoquinolyl-N-hydroxysuccinimidyl-carbamate (AQC) standard reagent solution (3-5 mg of AQC was dissolved in 1 ml of acetonitrile or reagent powder contained in AccQ-Fluor(Trademark) Reagent Kit by Nihon Waters was dissolved in 1 ml of reagent diluting solution) was added to this mixture. The obtained mixture was heated at 55° C. for 10 minutes. The derivatized amino acid mixture was diluted in 10 mM (NH₄)₂CO₃ dilution buffer (pH 8.7), and it was measured in a μchip electrophoresis mass spectrometer.

Measurement of Amino Acid with Modified Amino Group by the μChip Electrophoresis Mass Spectrometer

The μchip electrophoresis mass spectrometer was used by connecting a μchip electrophoresis instrument (this is the same instrument as disclosed in Japanese Patent Kokai Publication No. JP-P2001-83119A and and Y. Tachibana, K. Otsuka, S. Terabe, A. Arai, K. Suzuki, S. Nakamura, J. Chromatography. A, vol. 1025, pp. 287-296 (2004) equipped with an ESI emitter to a commercially available mass spectrometer.

### Conditions for μChip Electrophoresis

The material of the microchip was quartz and the channel shape was as follows: width of the channel was 82 μm; depth of the channel was 36 μm; and length of the separation channel was 59 mm. As a treatment for the channel surface, Positive EOF (silanol activation by alkaline) or Negative EOF (coated with PolyE-323) was used. As the ESI emitter, Picotip (FS360-50-15-N, New Objective) was used.

### Conditions for Electrophoresis

Sample introduction: Gate Injection method

Potential gradient: +400V/cm (Positive EOF)
−400V/cm (Negative EOF)

Gate ratio: 2.0

ESI voltage: 3.0 kV

### Measurement Conditions for the Mass Spectrometer

Instruments for measurement: ESI-Q-tof-2 (Micromass)

Measuring range for mass: m/z 160-800

Scan time: 1 second (1 scan is integration for 1 second)

Time between scans: 0.1 second

Cone voltage: 30V

Collision voltage: 10V

Data processing: MassLynx v.3.5(Micromass)

### Results

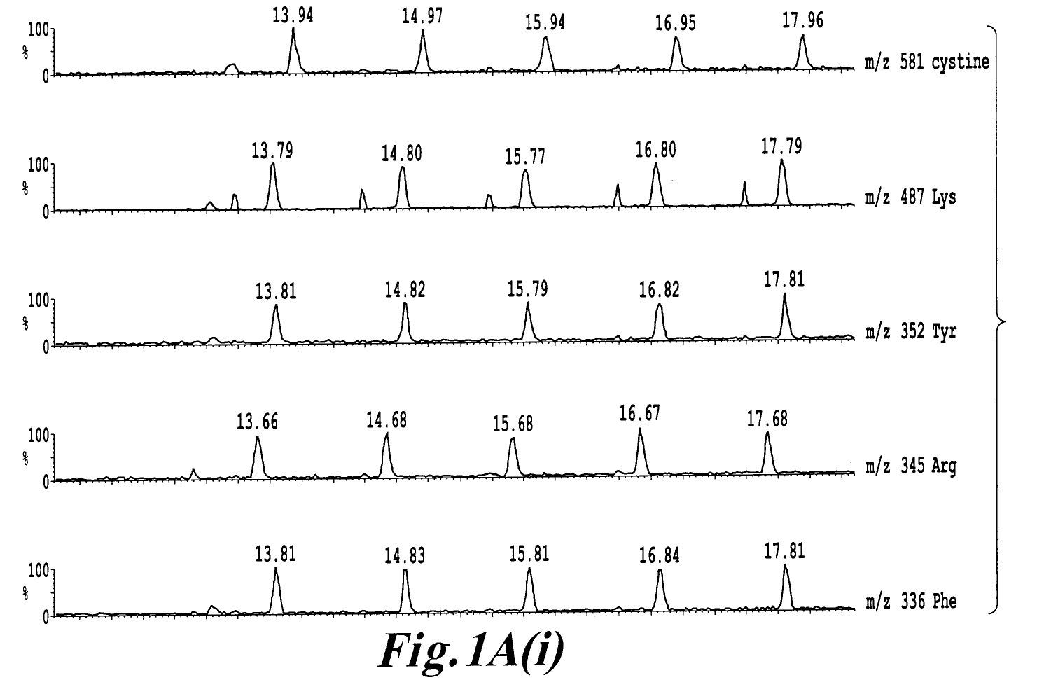

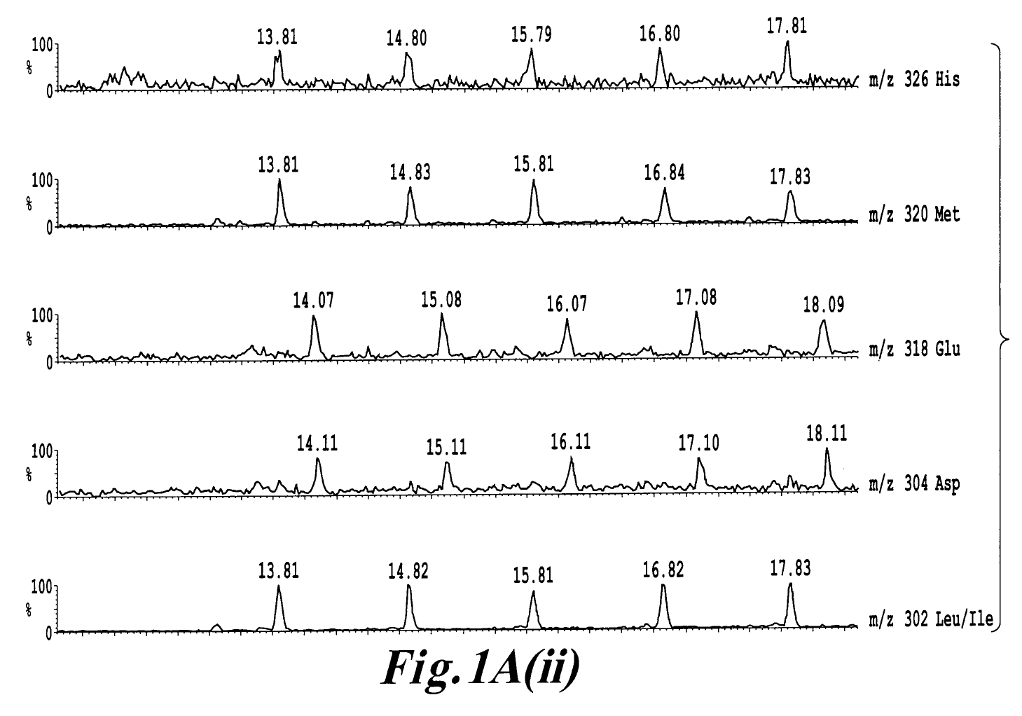

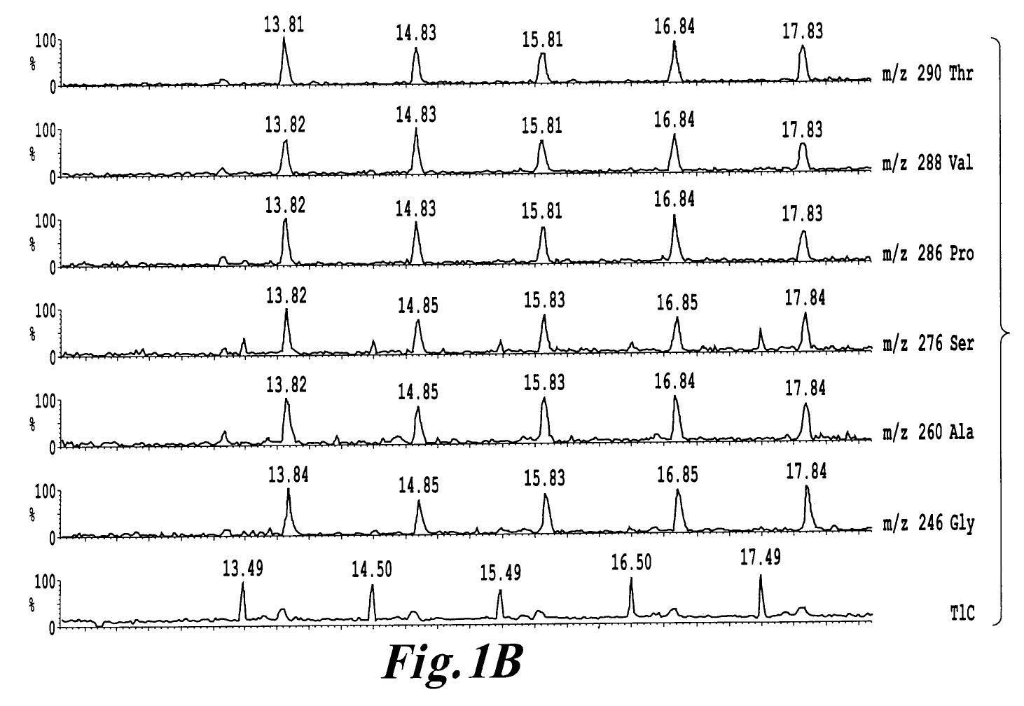

The mass electropherograms for analyzing samples of 17 kinds amino acids derivatized with AQC at the same time by using non-coating microchip are shown in FIGS. 1A and 1B. Samples were introduced for 1 second with the Gate Injection method at interval of 1 minute. All 17 kinds of amino acids derivatized with AQC were detected in every 1 minute.

Reproducibility of the samples introduction interval at this time is shown in following Table 1. Reproducibility of 5 times measurement was very accurate for all amino acids.

TABLE 1

| # | 1 | 2 | 3 | 4 | 5 | average | SD | RSD(%) |
|---|---|---|---|---|---|---|---|---|
| Gly | 59.4 | 60.0 | 58.8 | 60.0 | 59.4 | 59.52 | 0.502 | 0.8 |
| Ala | 58.2 | 60.0 | 58.8 | 59.4 | 59.4 | 59.16 | 0.684 | 1.2 |
| Ser | 58.2 | 60.0 | 58.8 | 60.0 | 59.4 | 59.28 | 0.782 | 1.3 |
| Pro | 58.2 | 58.8 | 57.6 | 59.4 | 58.8 | 58.56 | 0.684 | 1.2 |
| Val | 58.2 | 58.8 | 57.6 | 59.4 | 58.8 | 58.56 | 0.684 | 1.2 |
| Thr | 57.6 | 58.8 | 57.6 | 59.4 | 58.8 | 58.44 | 0.805 | 1.4 |
| Le/Il | 57.6 | 58.2 | 57.6 | 58.2 | 58.8 | 58.08 | 0.502 | 0.9 |
| Asp | 75.6 | 75.6 | 75.6 | 75.0 | 75.6 | 75.48 | 0.268 | 0.4 |
| Glu | 73.2 | 73.8 | 73.2 | 73.8 | 74.4 | 73.68 | 0.502 | 0.7 |
| Met | 57.6 | 58.8 | 57.6 | 59.4 | 58.8 | 58.44 | 0.805 | 1.4 |
| His | 57.6 | 57.0 | 56.4 | 57.0 | 57.6 | 57.12 | 0.502 | 0.9 |
| Phe | 57.6 | 58.8 | 57.6 | 59.4 | 57.6 | 58.20 | 0.849 | 1.5 |
| Arg | 48.6 | 49.8 | 49.8 | 49.2 | 49.8 | 49.44 | 0.537 | 1.1 |
| Tyr | 57.6 | 58.2 | 56.4 | 58.2 | 57.6 | 57.60 | 0.735 | 1.3 |
| Lys | 56.4 | 57.0 | 55.2 | 57.0 | 56.4 | 56.40 | 0.735 | 1.3 |
| cystine | 65.4 | 67.2 | 65.4 | 66.0 | 66.6 | 66.12 | 0.782 | 1.2 |

In the same way, a peak area, that is, reproducibility of quantifiability is shown in Table 2. Very high reproducibility was indicated for all amino acids when measuring 5 times.

TABLE 2

| # | 1 | 2 | 3 | 4 | 5 | average | SD | RSD(%) |
|---|---|---|---|---|---|---|---|---|
| Gly | 2.491 | 2.138 | 2.510 | 2.433 | 2.957 | 2.506 | 0.293 | 11.7 |
| Ala | 3.358 | 2.566 | 3.241 | 2.866 | 2.613 | 2.929 | 0.360 | 12.3 |
| Ser | 3.225 | 2.969 | 2.923 | 2.828 | 3.078 | 3.005 | 0.153 | 5.1 |
| Pro | 3.901 | 3.163 | 3.042 | 3.354 | 3.054 | 3.303 | 0.357 | 10.8 |
| Val | 5.148 | 5.436 | 4.916 | 4.785 | 4.376 | 4.932 | 0.397 | 8.1 |
| Thr | 3.976 | 3.888 | 3.334 | 3.558 | 3.673 | 3.686 | 0.258 | 7.0 |
| Le/Il | 11.206 | 10.707 | 10.535 | 11.236 | 11.18 | 10.973 | 0.327 | 3.0 |
| Asp | 2.748 | 2.365 | 2.343 | 2.298 | 2.783 | 2.507 | 0.237 | 9.5 |
| Glu | 3.440 | 2.943 | 2.550 | 3.102 | 3.054 | 3.018 | 0.321 | 10.6 |
| Met | 5.636 | 5.724 | 6.701 | 5.477 | 5.154 | 5.738 | 0.580 | 10.1 |
| His | 1.162 | 1.386 | 1.684 | 1.122 | 1.436 | 1.358 | 0.228 | 16.8 |
| Phe | 8.701 | 7.791 | 8.605 | 8.566 | 8.678 | 8.468 | 0.382 | 4.5 |
| Arg | 9.173 | 8.932 | 8.362 | 8.241 | 7.805 | 8.503 | 0.550 | 6.5 |
| Tyr | 9.187 | 8.319 | 8.424 | 8.611 | 8.461 | 8.600 | 0.344 | 4.0 |
| Lys | 16.872 | 16.174 | 15.056 | 17.615 | 16.345 | 16.412 | 0.943 | 5.7 |
| cystine | 5.722 | 5.101 | 6.019 | 4.859 | 4.877 | 5.316 | 0.526 | 9.9 |

### Example 2

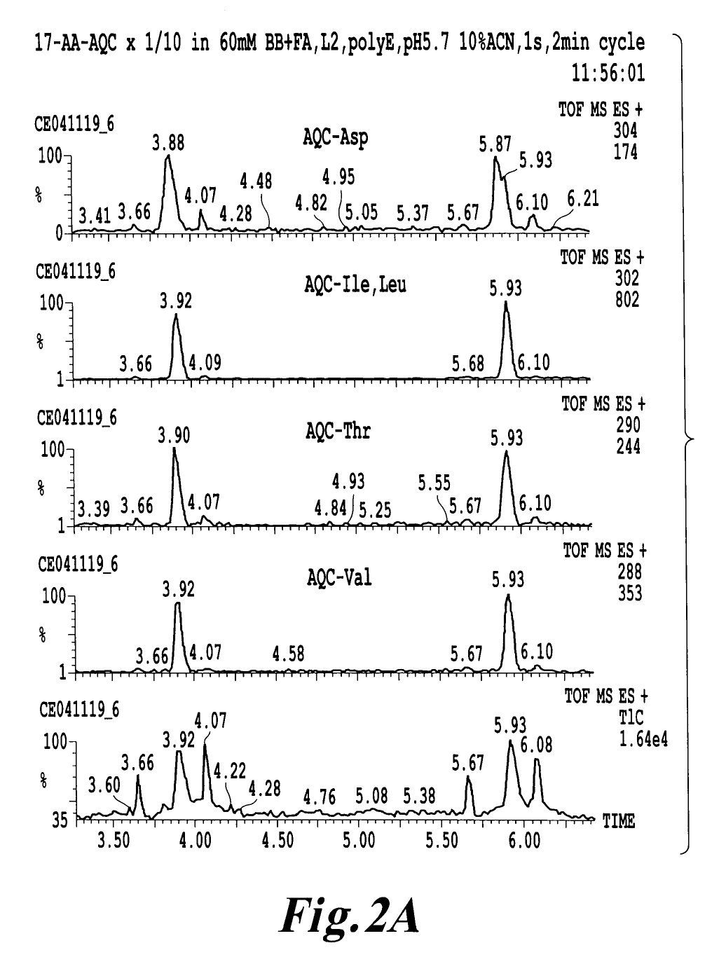

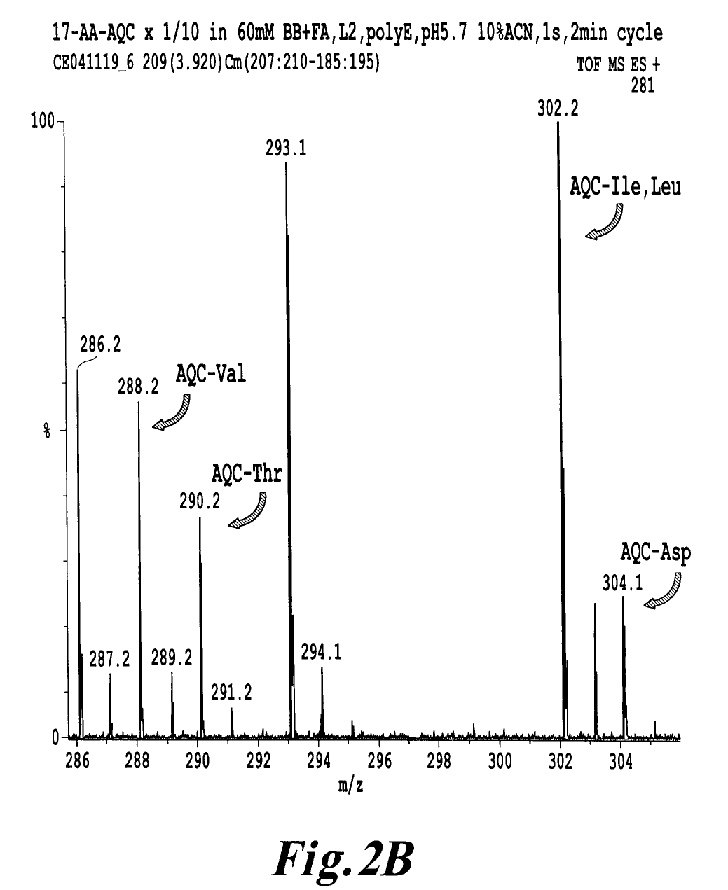

The mass electropherogram and mass spectra resulting from performing mass spectrometry which implements 1 second introduction in every 2 minutes for samples of 17 kinds amino acids derivatized with AQC at the same time as well as same method in Example 1 by using PolyE-323 coating microchip are shown in FIG. 2. Amino acids derivatized with AQC could be detected accurately at intervals of 2 minutes.

### Example 3

The mass electropherogram resulting from performing mass spectrometry which implements 1 second introduction with every 15 minutes interval for samples of amino acid mixture made with four kinds of Leu, Glu, Phe and Arg derivatized with AQC as well as the same method in Example 1 by using PolyE-323 coating microchip is shown in FIG. 3. Samples could be introduced correctly even at every 15 seconds interval and mass of samples could be measured. In this example, samples introduction was performed at every 15 seconds interval, but it is possible to perform at an interval of every 2 to 3 seconds.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method of analyzing a sample for the presence of an analyte which is one or more members selected from the group consisting of an amino acid, an amine, a peptide, and a mixture thereof, said method comprising:
(a) treating said sample with a modification reagent, to form a derivative of said analyte present in said sample and to obtain a treated sample;
(b) subjecting said treated sample to microchip electrophoresis, to obtain an eluate; and
(c) introducing said eluate into a mass spectrometer.

2. The method according to claim 1, wherein said derivative is one in which an amino group or an imino group of said analyte is converted into any one of a carbamoyl group, a thiocarbamoyl group, a tertiary amine, or a quaternary ammonium salt.

3. The method according to claim 1, wherein said derivative has a structure of a tertiary amine or a quaternary ammonium salt having an aromatic ring and said structure is easy to ionize in said mass spectrometer.

4. The method according to claim 1, wherein said derivative has a structure shown in any one of formulae (1) to (9): 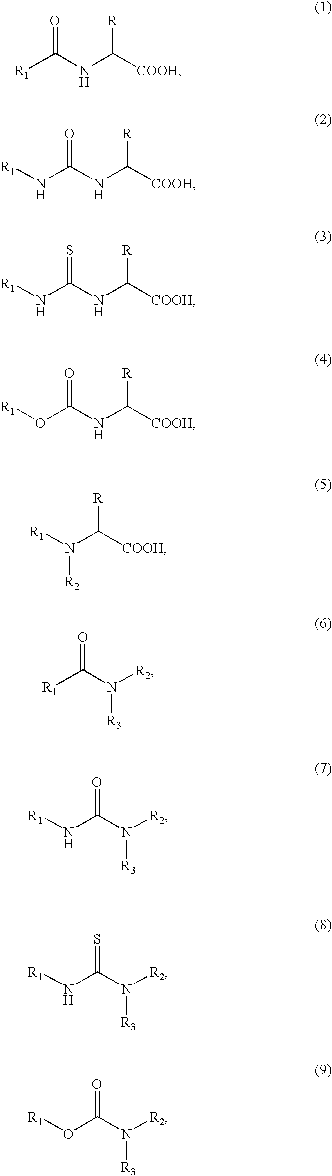
wherein in the above formulae (1) to (9), R represents a hydrogen atom or an alkyl group which may have a substituent group and is a side chain of an amino acid, R₁ represents an alkyl group which may have a substituent group or a substituted or unsubstituted group having an aromatic carbocyclic ring or an aromatic heterocyclic ring, R₂ and R₃ each independently represent an alkyl group which may have a substituent group, or R₂ and R₃ together may form a ring, or when one of R₂ and R₃ represents an amino acid residue of peptide, the other can be hydrogen atom.

5. The method according to claim 1, wherein said modification reagent comprises a compound selected from the group consisting of acetic aid anhydride, N-acetyl-imidazole, N-acetyl-succinimide, N-acetyl-imidoacetate, N-acetyl-imidazole, Bolton-Hunter reagent, a carbamate compound, an isothiocyanate compound, a N-hydroxy-succinimide-ester, dansyl-chloride, dabsyl-chloride, dansyl-fluoride, and (4-fluoro-7-nitrobenzofurazan).

6. The method according to claim 5, wherein said carbamate compound is selected from the group consisting of 6-aminoquinolyl-N-hydroxysuccinimidyl-carbamate, p-dimethylaminoanilyl-N-hydroxysuccinimidyl-carbamate, 3-aminopyridyl-N-hydroxysuccinimidyl-carbamate, p-trimethylammoniumanilyl-N-hydroxysuccinimidyl-carbamate-iodide, aminopyrazyl-N-hydroxysuccinimidyl-carbamate, 9-aminoacridyl-N-hydroxysuccinimidyl-carbamate, and 1-naphthylamino-N-hydroxysuccinimidyl-carbamate.

7. The method according to claim 5, wherein said isothiocyanate compound is phenyl isothiocyanate or fluorescein isothiocyanate.

8. The method according to claim 1, wherein said mass spectrometer is one selected from the group consisting of an electro-spray-ionization mass spectrometer, an atmospheric pressure chemical ionization mass spectrometer, a cold-spray-ionization mass spectrometer, and a laser-spray-ionization mass spectrometer.

9. A method for supplying a sample which may contain a plurality of analytes which may comprise one or more members selected from the group consisting of an amino acid, an amine, a peptide, and a mixture thereof to an analysis instrument, said method comprising:
(a) treating said sample with a modification reagent to obtain a treated sample and to convert analyte present in said sample to a derivative as shown in formulae (1) to (9): 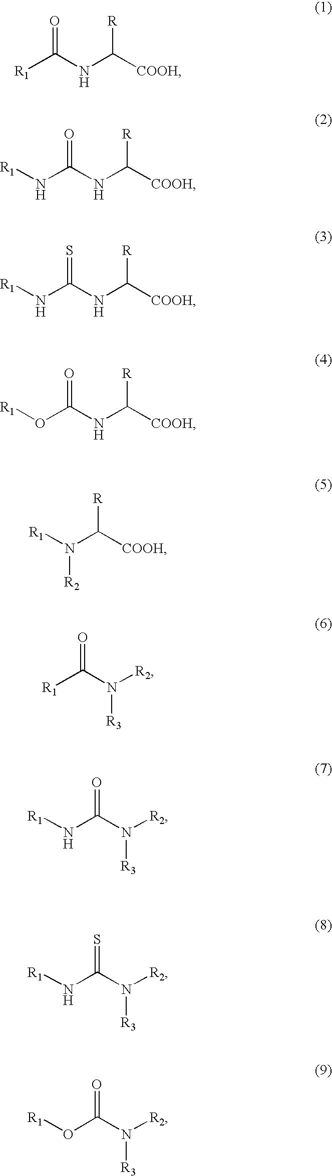
wherein in the above formulae (1) to (9), R represents a hydrogen atom or an alkyl group which may have a substituent group and is a side chain of an amino acid, R₁ represents an alkyl group which may have a substituent group or a substituted or unsubstituted group having an aromatic carbocyclic ring or an aromatic heterocyclic ring, R₂ and R₃ each independently represent an alkyl group which may have a substituent group, or R₂ and R₃ together may form a ring, or when one of R₂ and R₃ represents an amino acid residue of peptide, the other can be hydrogen atom;
(b) subjecting said derivative to electrophoresis with a microchip electrophoresis device, to obtain an eluate; and
(c) supplying said eluate to one or more inlets of said analysis instrument.

10. A pretreatment instrument for analyzing a sample for the presence of an analyte which is one or more members selected from the group consisting of an amino acid, an amine, a peptide, and a mixture thereof, with a mass spectrometer, said pretreatment instrument comprising:
a reaction part for reacting said sample with a modification reagent to convert analyte present in said sample to a derivative as shown in formulae (1) to (9): 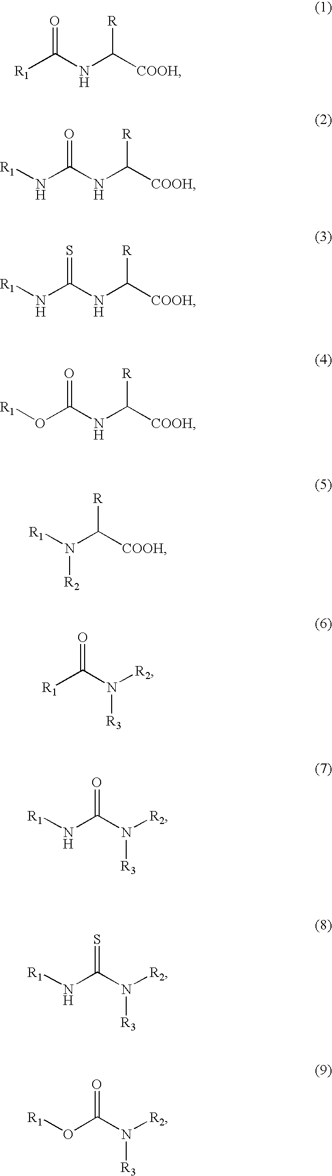
wherein in the above formulae (1) to (9), R represents a hydrogen atom or an alkyl group which may have a substituent group and is a side chain of an amino acid, R₁ represents an alkyl group which may have a substituent group or a substituted or unsubstituted group having an aromatic carbocyclic ring or an aromatic heterocyclic ring, R₂ and R₃ each independently represent an alkyl group which may have a substituent group, or R₂ and R₃ together may form a ring, or when one of R₂ and R₃ represents an amino acid residue of peptide, the other can be hydrogen atom; and
a microchip electrophoresis part for performing electrophoresis of said derivative.
